(19) United States
(12) Patent Application Publication
(10) Pub. No.: US 2014/0211794 A1
(43) Pub. Date: Jul. 31, 2014

(54) Signaling Using a Time-to-Live (TTL) Field of a Packet

(71) Applicants: Daniel C. Frost, Feltham (GB); Stewart Frederick Bryant, Surrey (GB); Clarence Filsfils, Brussels (BE)

(72) Inventors: Daniel C. Frost, Feltham (GB); Stewart Frederick Bryant, Surrey (GB); Clarence Filsfils, Brussels (BE)

(21) Appl. No.: 13/756,490

(22) Filed: Jan. 31, 2013

(51) Int. Cl. H04L 12/56

(52) U.S. Cl. CPC H04L 45/20
USPC 370/389

(57) ABSTRACT

In one embodiment, a Time-to-Live (TTL) field of a packet is used to signal information (other than normal other than a life span of the packet or distance information relative to the network node). The packet is sent through a network, which typically includes traversing one or more intermediate nodes resulting in a modification of its TTL field (e.g., each node reduces the TTL value). After receiving the packet, a network node interprets the current value of the TTL field to identify the particular information encoded in the TTL field. Typically the current value of the TTL field is compared to a range of possible values to accommodate different TTL reductions due to different paths through a network. Signaling using the TTL value may be advantageous in networks that perform Equal-Cost-Multi-Path (ECMP) routing as the TTL value does not effect this routing.

### TECHNICAL FIELD

The present disclosure relates generally to forwarding packets in a communications network.

### BACKGROUND

The communications industry is rapidly changing to adjust to emerging technologies and ever increasing customer demand. This customer demand for new applications and increased performance of existing applications is driving communications network and system providers to employ networks and systems having greater speed and capacity (e.g., greater bandwidth). In trying to achieve these goals, a common approach taken by many communications providers is to use packet switching technology.

The control information contained in a packet (e.g., Internet Protocol packet, Multiprotocol Label Switching packet) typically contains a Time-to-Live (TTL) value in a TTL field (e.g., in a header, in a label). The TTL value is typically decremented by each network node that the packet traverses so that the life span of a packet is limited.

### BRIEF DESCRIPTION OF THE DRAWINGS

The appended claims set forth the features of one or more embodiments with particularity. The embodiment(s), together with its advantages, may be best understood from the following detailed description taken in conjunction with the accompanying drawings of which:

FIG. 1A illustrates a network operating according to one embodiment;

FIG. 1B illustrates a network operating according to one embodiment;

FIG. 1C illustrates a network operating according to one embodiment;

FIG. 1D illustrates a network operating according to one embodiment;

FIG. 2A illustrates a packet switching device according to one embodiment;

FIG. 2B illustrates an apparatus according to one embodiment;

FIG. 3 illustrates a process according to one embodiment; and

FIG. 4 illustrates a process according to one embodiment.

### DESCRIPTION OF EXAMPLE EMBODIMENTS

### 1. Overview

Disclosed are, inter alia, methods, apparatus, computer-storage media, mechanisms, and means associated with signaling using a Time-to-Live (TTL) field of a packet. In one embodiment, a network node sets a Time-to-Live (TTL) field of a packet to a value to signal to a different network node particular information, other than a life span of the packet or distance information relative to the network node. The packet is sent through a network to the different network node, which includes traversing one or more intermediate nodes which results in a modification of the value of the TTL field of the packet (e.g., each node reduces the TTL value typically by decrementing its current value by one). After receiving the packet, the different network node interprets the current value of the TTL field to identify the particular information. The different node typically then reacts to the particular information signaled in the packet.

In one embodiment, interpreting the TTL includes determining that the current value of the TTL field is a specific predetermined value. In one embodiment, interpreting the TTL field includes determining that the current value of the TTL field is within a node-traversal-TTL-adjustment-accommodating range including at least two values. In one embodiment, multiple ranges are used to signal different information. Using a predetermined range of values instead of a specific predetermined value accommodates changes in a network, and/or an unknown or different path of a packet taken through the network which might vary the amount that a TTL value is reduced in a packet as it traverses the network between sending and receiving nodes.

In one embodiment, signaling said particular information identifies that the packet is not a normal data packet. In one embodiment, said signaling identifies that the packet is an Operations, Administration or Maintenance (OAM) packet.

### 2. Description

Disclosed are, inter alia, methods, apparatus, computer-storage media, mechanisms, and means associated with signaling using a Time-to-Live (TTL) field of a packet.

Embodiments described herein include various elements and limitations, with no one element or limitation contemplated as being a critical element or limitation. Each of the claims individually recites an aspect of the embodiment in its entirety. Moreover, some embodiments described may include, but are not limited to, inter alia, systems, networks, integrated circuit chips, embedded processors, ASICs, methods, and computer-readable media containing instructions. One or multiple systems, devices, components, etc., may comprise one or more embodiments, which may include some elements or limitations of a claim being performed by the same or different systems, devices, components, etc. A processing element may be a general processor, task-specific processor, a core of one or more processors, or other co-located, resource-sharing implementation for performing the corresponding processing. The embodiments described hereinafter embody various aspects and configurations, with the figures illustrating exemplary and non-limiting configurations. Computer-readable media and means for performing methods and processing block operations (e.g., a processor and memory or other apparatus configured to perform such operations) are disclosed and are in keeping with the extensible scope of the embodiments. The term “apparatus” is used consistently herein with its common definition of an appliance or device.

The steps, connections, and processing of signals and information illustrated in the figures, including, but not limited to, any block and flow diagrams and message sequence charts, may typically be performed in the same or in a different serial or parallel ordering and/or by different components and/or processes, threads, etc., and/or over different connections and be combined with other functions in other embodiments, unless this disables the embodiment or a sequence is explicitly or implicitly required (e.g., for a sequence of read the value, process said read value—the value must be obtained prior to processing it, although some of the associated processing may be performed prior to, concurrently with, and/or after the read operation). Also, nothing described or referenced in this document is admitted as prior art to this application unless explicitly so stated.

The term “one embodiment” is used herein to reference a particular embodiment, wherein each reference to “one embodiment” may refer to a different embodiment, and the use of the teem repeatedly herein in describing associated features, elements and/or limitations does not establish a cumulative set of associated features, elements and/or limitations that each and every embodiment must include, although an embodiment typically may include all these features, elements and/or limitations. In addition, the terms “first,” “second,” etc., are typically used herein to denote different units (e.g., a first element, a second element). The use of these terms herein does not necessarily connote an ordering such as one unit or event occurring or coming before another, but rather provides a mechanism to distinguish between particular units. Moreover, the phrases “based on x” and “in response to x” are used to indicate a minimum set of items “x” from which something is derived or caused, wherein “x” is extensible and does not necessarily describe a complete list of items on which the operation is performed, etc. Additionally, the phrase “coupled to” is used to indicate some level of direct or indirect connection between two elements or devices, with the coupling device or devices modifying or not modifying the coupled signal or communicated information. Moreover, the term “or” is used herein to identify a selection of one or more, including all, of the conjunctive items. Additionally, the transitional term “comprising,” which is synonymous with “including,” “containing,” or “characterized by,” is inclusive or open-ended and does not exclude additional, unrecited elements or method steps. Finally, the term “particular machine,” when recited in a method claim for performing steps, refers to a particular machine within the 35 USC §101 machine statutory class.

Disclosed are, inter alia, methods, apparatus, computer-storage media, mechanisms, and means associated with signaling using a Time-to-Live (TTL) field of a packet. In one embodiment, a network node sets a TTL field of a packet to a particular value to signal to a different network node particular information, other than a life span of the packet or distance information relative to the network node. The packet is sent through a network to the different network node, which includes traversing one or more intermediate nodes which results in a modification of the value of the TTL field of the packet (e.g., each node reduces the TTL value). After receiving the packet, the different network node interprets the current value of the TTL field to identify the particular information. The different node typically then reacts to the particular information signaled in the packet.

In one embodiment, interpreting the TTL includes determining that the current value of the TTL field is a specific predetermined value. In one embodiment, interpreting the TTL field includes determining that the current value of the TTL field is within a node-traversal-TTL-adjustment-accommodating range including at least two values. In one embodiment, multiple ranges are used to signal different information. Using a predetermined range of values instead of a specific predetermined value accommodates changes in a network, and/or an unknown or different path of a packet taken through the network which might vary the amount that a TTL value is reduced in a packet as it traverses the network between sending and receiving nodes. Also, signaling can be performed in a sequence of packets, possibly successive packets, to transmit information which requires more bandwidth than can be communicated in the TTL field of a single packet, whether interpreting according to a single range or multiple ranges.

In one embodiment, signaling said particular information identifies that the packet is not a normal data packet. In one embodiment, said signaling identifies that the packet is an Operations, Administration or Maintenance (OAM) packet. In one embodiment, said signaling identifies that the packet is of a particular traffic class. This signaling technique can be used to signal any information desired to be communicated between a sending node and a receiving node (which could include intermediate node(s) and/or the end receiving node).

An advantage of using the TTL field is that networks do not perform Equal-Cost-Multi-Path (ECMP) routing based on the TTL field that varies as it goes through the network. Thus, this signaling of information using the TTL field of a packet does not (or typically does not) affect the path taken by the packet. Also, intermediate nodes do not need to be modified to process this new signaling protocol as they can process the TTL field as normal (e.g., reduce it) without regards to information possibly signaled therein by another node.

Further, edge nodes of a network can signal using the TTL field of a packet received from a customer network, with this signaling removed by another edge node prior to transmittal onto a customer network, typically so that the customer network will be oblivious to the signaling using the TTL field. In one embodiment, such removing of the TTL signaling includes decreasing or otherwise adjusting the TTL value of a packet such that it becomes the value it would have been if TTL signaling was not used. For example, if the sending node normally initially sets the TTL field to a value of n (e.g., thirty-two) when TTL signaling is not used, and the sending node normally initially sets the TTL field to a value of n+s (e.g., one hundred thirty-two), then such removing of the TTL signaling may include decreasing the current TTL value of the packet by s (e.g., one hundred).

In one embodiment, edge nodes will not use TTL signaling of information in a packet whose TTL field is expected to expire within the provider/core network so that the packet will be normally dropped, traceroute will work properly, etc. In one embodiment, edge nodes will use TTL signaling of information in a packet whose TTL field is expected to expire within the provider/core network. In one embodiment, these provider/core network node(s) will mask the TTL field or otherwise decrease the current value of the TTL field to remove any such TTL signaling for purposes of their internal processing of the TTL field so that the packet will be normally dropped or other normal processing performed upon expiry of the TTL value without the added TTL signaling.

One embodiment includes a method, comprising: setting, by a network node of a network, a Time-to-Live (TTL) field of a packet to a value to signal to a different network node particular information, with said particular information being other than a life span of the packet and other than distance information including distance information relative to the network node and distance information relative to the different network node; sending the packet through the network to the different network node, including traversing one or more intermediate nodes which results in a modification of the value of the TTL field of the packet; and interpreting, by the different network node, a current value of the TTL field to determine the packet is signaling said particular information.

In one embodiment, at least one of said one or more intermediate nodes performs on the packet Equal-Cost-Multi-Path (ECMP) routing exclusive of the value of the TTL field. In one embodiment, said interpreting the current value of the TTL field to determine the packet is signaling said particular information includes determining that the current value of the TTL field is within a node traversal-TTL-adjustment-accommodating range including at least two values. One embodiment includes setting, by the network node, the Time-to-Live (TTL) field of a second packet to the value; sending the second packet through the network to a second different network node; and interpreting, by the second different network node, the current value of the TTL field of the second packet to determine that the second packet is signaling said particular information; wherein the current value of the TTL field of the second packet when said interpreted by the second different network node is different than the current value of the packet when said interpreted by the different network node.

In one embodiment, said particular information signals that the packet is not a normal data packet. In one embodiment, said particular information signals that the packet is an Operations, Administration or Maintenance (OAM) packet. In one embodiment, said particular information signals that the packet is particularly marked or particularly colored. In one embodiment, said particular information signals that the packet is of a particular type or packet format (e.g., the packet includes metadata, the packet switching device determines how to interpret the packet based on the particular type or format).

One embodiment includes a method, comprising: signaling, by a sending network node for interpretation by a receiving network node, particular information in a Time-to-Live (TTL) field of a packet sent to the receiving network node, with said particular information being other than a life span of the packet and other than distance information including distance information relative to the sending network node and distance information relative to the receiving network node.

In one embodiment, said particular information is said signaled by setting the TTL field to a particular value and sending the packet from the sending network node such that the value of the TTL field of the packet at the receiving network node will be interpreted as said particular information by the receiving network node after the packet has traversed one or more intermediate network nodes between the sending network node and the receiving network node including at least one of said one or more intermediate network nodes decreasing the value of the TTL field. In one embodiment, the operation of interpreted as said particular information by the receiving node is based on the value of the TTL field being within a node traversal TTL adjustment-accommodating range including at least two values. In one embodiment, the node-traversal-TTL-adjustment-accommodating range includes at least sixteen different values. In one embodiment, the particular value is at least thirty-two and less than 255.

In one embodiment, the packet is an IP packet. In one embodiment, the packet is a Multiprotocol Label Switched (MPLS) packet. In one embodiment, the packet is an Ethernet packet (e.g., also sometimes referred to as an Ethernet frame). In one embodiment, the packet is a TRansparent Interconnection of Lots of Links (TRILL) packet. In one embodiment, the packet is a different packet than just listed. In one embodiment, said sending the packet from the sending network node includes sending, by the sending network node, the packet through a tunnel to the receiving node.

One embodiment includes a packet switching device, comprising: one or more processing elements; memory; a plurality of interfaces configured for sending and receiving packets; and one or more packet switching mechanisms configured to packet switch packets among said interfaces; wherein said one or more processing elements are configured to perform operations, including signaling and/or interpreting signaling of information in a TTL field of a packet, with this signaled information being other than a life span of the packet and other than distance information.

In one embodiment, said interpreting the current value of the TTL field to determine particular signaled information includes determining that the current value of the TTL field is within a node-traversal-TTL-adjustment-accommodating range including at least two values. In one embodiment, the current value of the TTL field is at least thirty-two and less than 252. In one embodiment, said particular signaled information signals that the packet is not a normal data packet, that the packet is an Operations, Administration or Maintenance (OAM) packet, that the packet is particularly marked, that the packet is particularly colored, that the packet is of a particular type, or that the packet is of a particular packet format.

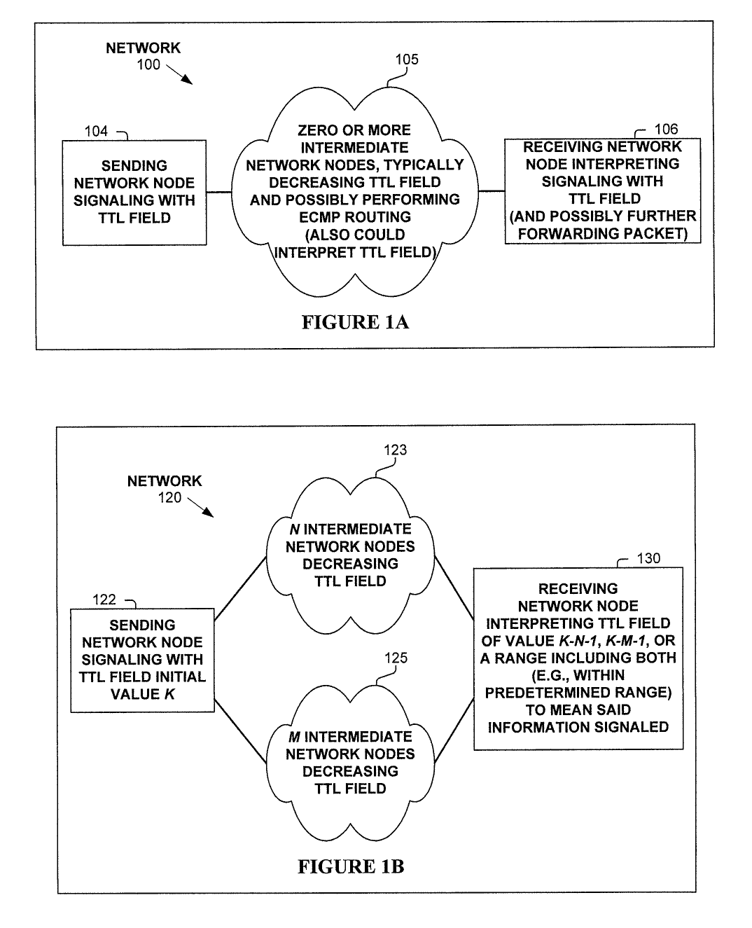

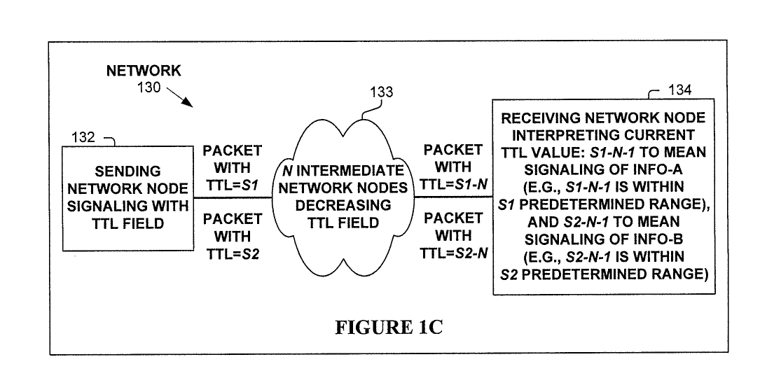

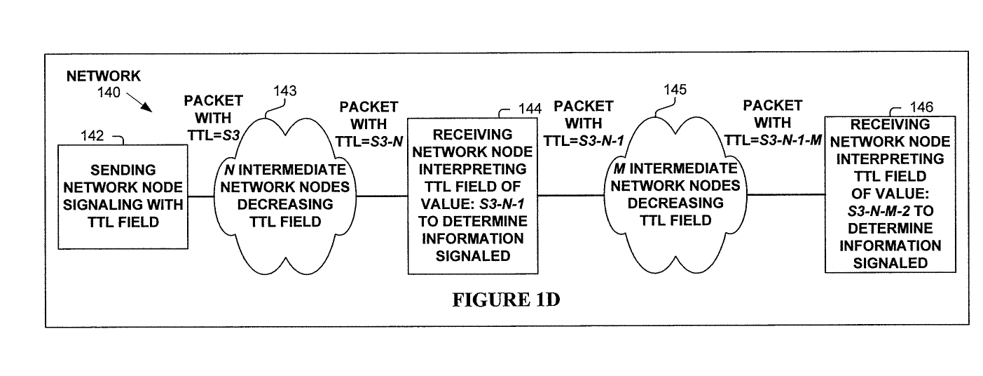

Turning to the figures, FIG. 1A illustrates a network 100 operating according to one embodiment. As shown, sending network node 104 signals information to receiving network node 106, which interprets the TTL field to identify the signaled information. Also, a packet sent between network nodes 104 and 106 traverse zero or more intermediate network nodes 105 that each typically decrease the value of the TTL field in the packet (e.g., by one). One or more of intermediate network nodes 105 may interpret or ignore the signaling using the TTL field of a packet. Note, the network paths illustrated in each of figures herein may, or may not, include one or more tunnels such as a tunnel terminated on both the sending and receiving network nodes using TTL signaling.

The TTL field of an IP packet has eight bits, so it can have a value ranging from zero to 255. An initial value of thirty-two or sixty-four is not uncommon, especially as a packet does not typically traverse more than twenty nodes in a network, such as the Internet. The TTL field thus has unused bandwidth than can be used to signal information.

Assume that the maximum number reduction of a TTL value of a packet traversing a network without a routing error is R (e.g., twenty), and the TTL value is normally set to T (e.g., sixty-four). By setting the TTL value to be at least R+T+1, a test can be done at the receiving node of if the TTL value of a received packet is greater than T, then information has been signaled. For example, this signaling can be used to identify the packet as not a normal data packet (e.g., an OAM packet).

Also, by having a bounding value of R, more information can be signaled in a TTL field. For example, assume R is twenty. A router could set the TTL value to be 250 to signal information-A, to 220 to signal information-B, etc. The receive node could interpret the received value (V) of the TTL field such as if V has a value in the range of 230-249, then information-A is signaled; else if V has a value in the range of 200-219, then information-B is signaled; else no information is signaled.

FIG. 1B illustrates a network 120 operating according to one embodiment. FIG. 1B illustrates an advantageous use of a range in interpreting the TTL field in determining signaled information, if any. Network node 122 signals information to receiving network node 130 using the TTL field of a packet. The packet could either traverse the path including N intermediate network nodes 123 or the path including M intermediate network nodes 125. Thus, the TTL value of the packet at receiving network node 130 will be either K−N−1 or K−M−1 (assuming that receiving network node 130 decreases the TTL value by one upon receipt). Receiving node 130 can readily identify whether or not the information is signaled in the TTL field by testing the current value at receiving node 130 against a predetermined range that includes both of the values K−N−1 and K−M−1 (and is above a minimum threshold to avoid normal TTL operations).

FIG. 1C illustrates a network 130 operating according to one embodiment. FIG. 1C illustrates an advantageous use of multiple ranges in interpreting the TTL field in determining different signaled information, if any. Network node 132 is configured to signal information-A using an initial TTL value of S1, signal information-B using an initial TTL value of S2, or no information-A or information-B in the TTL field of a packet sent to receiving network node 134. In this embodiment, there are N intermediate network nodes 133, each of which will decrease the TTL value by one. Thus, when information-A is signaled, the TTL value of the packet will be S1−N, and when information-B is signaled, the TTL value of the packet will be S2−N Assuming receiving network node 134 also decreases the TTL value of a packet upon receipt, receiving network node 134 will interpret a current TTL value in a first range including S1−N−1 to signal information-A, and a current TTL value in a second range including S2−N−1 to signal information-B. Note, these different ranges are typically predetermined to accommodate different paths through the network that a packet may take (hence, its TTL value decreased by differing amounts depending on the path taken), which includes accommodating for fast rerouting of paths through a network.

FIG. 1D illustrates a network 140 operating according to one embodiment. FIG. 1D illustrates that this signaling using a TTL value of a packet may signal multiple network nodes 144 and 146. As shown, network node 142 sends a packet with a TTL of an initial value of S3 to signal information. After traversing N intermediate nodes 143 and being received at node 144 with the TTL value further reduced by one, the current TTL value of the packet is S3−N−1. The packet is then forwarded through M intermediate nodes 145 and received at node 146 with the TTL value further reduced by one, the current TTL value of the packet is S3−N−M−2. Nodes 144 and 146 can individually test for these respective current TTL values, or both could use a same test that includes both of these current TTL values. Assume that the maximum number reduction of a TTL value of the packet traversing network 140 without a routing error is R (e.g., twenty). Then, the range can be from, or include, (S3−R) to (S3−1). In one embodiment, S3 is larger than the normal TTL initial value plus (R+1) and less than 255 to isolate the TTL signaling of information from normal TTL processing (which may be advantageous when all traversed network nodes are not programmed to recognize or otherwise accommodate this TTL signal of information).

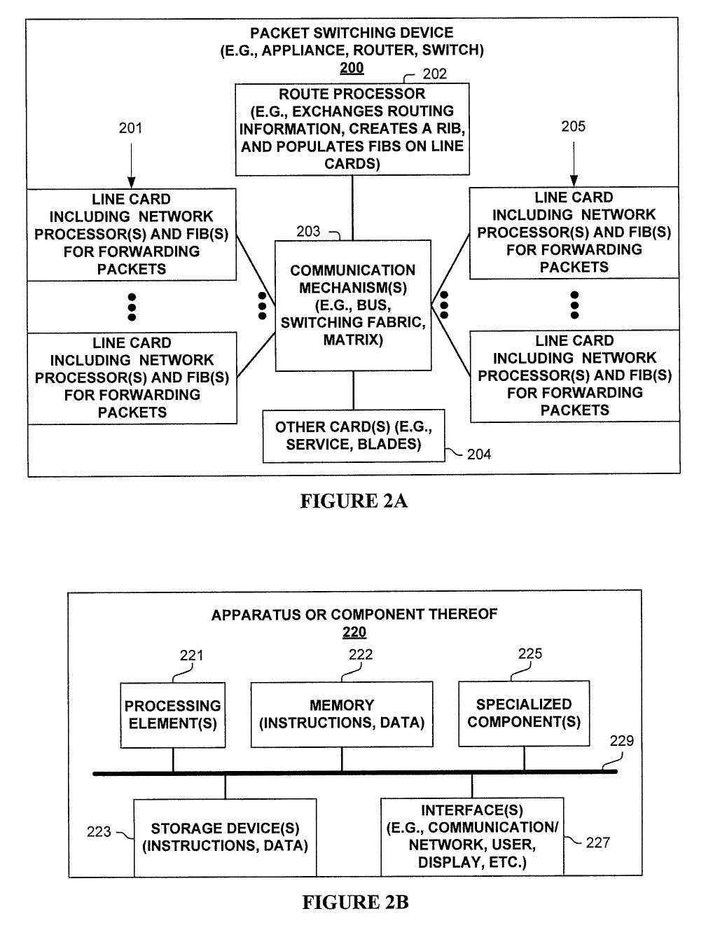

One embodiment of a packet switching device 200 is illustrated in FIG. 2A. As shown, packet switching device 200 includes multiple line cards 201 and 205, each with one or more network interfaces for sending and receiving packets over communications links (e.g., possibly part of a link aggregation group), and with one or more processing elements that are used in one embodiment associated with signaling using a Time-to-Live (TTL) field of a packet. Packet switching device 200 also has a control plane with one or more processing elements 202 for managing the control plane and/or control plane processing of packets associated with signaling using a Time-to-Live (TTL) field of a packet. Packet switching device 200 also includes other cards 204 (e.g., service cards, blades) which include processing elements that are used in one embodiment to process packets associated with signaling using a Time-to-Live (TTL) field of a packet, and some communication mechanism 203 (e.g., bus, switching fabric, matrix) for allowing its different entities 201, 202, 204 and 205 to communicate.

FIG. 2B is a block diagram of an apparatus 220 used in one embodiment associated with signaling using a Time-to-Live (TTL) field of a packet. In one embodiment, apparatus 220 performs one or more processes, or portions thereof, corresponding to one of the flow diagrams illustrated or otherwise described herein, and/or illustrated in another diagram or otherwise described herein.

In one embodiment, apparatus 220 includes one or more processing element(s) 221, memory 222, storage device(s) 223, specialized component(s) 225 (e.g. optimized hardware such as for performing lookup and/or packet processing operations, etc.), and interface(s) 227 for communicating information (e.g., sending and receiving packets, user-interfaces, displaying information, etc.), which are typically communicatively coupled via one or more communications mechanisms 229, with the communications paths typically tailored to meet the needs of a particular application.

Various embodiments of apparatus 220 may include more or fewer elements. The operation of apparatus 220 is typically controlled by processing element(s) 221 using memory 222 and storage device(s) 223 to perform one or more tasks or processes. Memory 222 is one type of computer-readable/computer-storage medium, and typically comprises random access memory (RAM), read only memory (ROM), flash memory, integrated circuits, and/or other memory components. Memory 222 typically stores computer-executable instructions to be executed by processing element(s) 221 and/or data which is manipulated by processing element(s) 221 for implementing functionality in accordance with an embodiment. Storage device(s) 223 are another type of computer-readable medium, and typically comprise solid state storage media, disk drives, diskettes, networked services, tape drives, and other storage devices. Storage device(s) 223 typically store computer-executable instructions to be executed by processing element(s) 221 and/or data which is manipulated by processing element(s) 221 for implementing functionality in accordance with an embodiment.

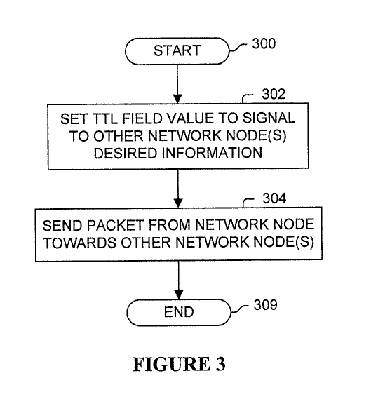

FIG. 3 illustrates a process performed in one embodiment. Processing begins with process block 300. In process block 302, a sending packet switching sets the TTL field of a packet to a value to signal the desired information. In process block 304, the packet is sent towards the other network node(s) that are to receive the information. Processing of the flow diagram of FIG. 3 is complete as indicated by process block 309.

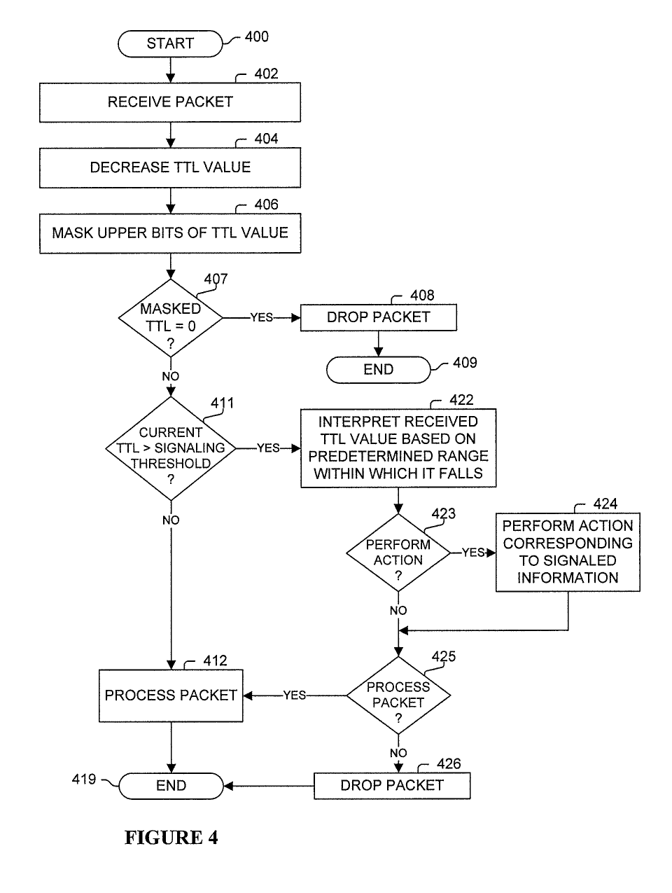

FIG. 4 illustrates a process performed in one embodiment. Processing begins with process block 400. In process block 402, a packet is received; and in process block 404, the TTL of the packet is reduced by one. In process block 406, the upper bits of the TTL value are masked to remove any signaling by a sending node so that normal TTL processing can be performed. In one embodiment, this masking ensures that the TTL value is no larger than the usual initial value of a TTL field when no signaling is added to the TTL field of a packet. In one embodiment, a predetermined value is subtracted to remove the TTL signaling rather than masking to accomplish the same purpose. For example, if the sending node normally initially sets the TTL field to a value of n (e.g., thirty-two) when TTL signaling is not used, and the sending node normally initially sets the TTL field to a value of n+s (e.g., one hundred thirty-two), then the current TTL value of the packet is decreased by s (e.g., one hundred) in one embodiment. As determined in process block 407, if the masked TTL value (or otherwise adjusted TTL value to remove the TTL signaling) is zero, then the packet is considered as an expiry packet, and dropped in one embodiment in process block 408. Processing of the flow diagram of FIG. 4 is then complete as indicated by process block 409.

Otherwise, as determined in process block 407, the packet is not expiry, and processing continues to process block 411. If the current TTL value of the packet is greater than a signaling threshold (e.g., greater than a normal TTL initial value minus one to avoid conflicting with normal TTL operations), then processing proceeds to process block 422. Otherwise, processing proceeds to process block 412 (as TTL signaling was not used) to process the packet, with processing of the flow diagram of FIG. 4 then being complete as indicated by process block 419.

In process block 422, the current TTL value of the packet is interpreted based on one or more predetermined ranges (e.g., single value, two or more values) to identify the corresponding signaled information. As determined in process block 423, if some action should be performed based on the identified information (e.g., it is an OAM packet), then this action (e.g., OAM processing) is performed in process block 424. In one embodiment, such processing includes decreasing or otherwise adjusting the TTL value of a packet such that it becomes the value it would have been if TTL signaling was not used. For example, if the sending node normally initially sets the TTL field to a value of n (e.g., thirty-two) when TTL signaling is not used, and the sending node normally initially sets the TTL field to a value of n+s (e.g., one hundred thirty-two), then such processing may include decreasing the current TTL value of the packet by s (e.g., one hundred).

As determined in process block 425, if the packet should be dropped, then it is dropped in process block 426; otherwise the packet is processed in process block 412.

Processing of the flow diagram of FIG. 4 is then complete as indicated by process block 419.

In view of the many possible embodiments to which the principles of the disclosure may be applied, it will be appreciated that the embodiments and aspects thereof described herein with respect to the drawings/figures are only illustrative and should not be taken as limiting the scope of the disclosure. For example, and as would be apparent to one skilled in the art, many of the process block operations can be re-ordered to be performed before, after, or substantially concurrent with other operations. Also, many different forms of data structures could be used in various embodiments. The disclosure as described herein contemplates all such embodiments as may come within the scope of the following claims and equivalents thereof.

What is claimed is:

1. A method, comprising:
setting, by a network node of a network, a Time-to-Live (TTL) field of a packet to a value to signal to a different network node particular information, with said particular information being other than a life span of the packet and other than distance information including distance information relative to the network node and distance information relative to the different network node;
sending the packet through the network to the different network node, including traversing one or more intermediate nodes which results in a modification of the value of the TTL field of the packet; and
interpreting, by the different network node, a current value of the TTL field to determine the packet is signaling said particular information.

2. The method of claim 1, wherein at least one of said one or more intermediate nodes performs on the packet Equal-Cost-Multi-Path (ECMP) routing exclusive of the value of the TTL field.

3. The method of claim 1, wherein said interpreting the current value of the TTL field to determine the packet is signaling said particular information includes determining that the current value of the TTL field is within a node-traversal-TTL-adjustment-accommodating range including at least two values.

4. The method of claim 1, comprising:
setting, by the network node, the Time-to-Live (TTL) field of a second packet to the value;
sending the second packet through the network to a second different network node; and
interpreting, by the second different network node, the current value of the TTL field of the second packet to determine that the second packet is signaling said particular information;
wherein the current value of the TTL field of the second packet when said interpreted by the second different network node is different than the current value of the packet when said interpreted by the different network node.

5. The method of claim 1, wherein said particular information signals that the packet is not a normal data packet.

6. The method of claim 5, wherein said particular information signals that the packet is an Operations, Administration or Maintenance (OAM) packet.

7. The method of claim 1, wherein said particular information signals that the packet is particularly marked or particularly colored.

8. The method of claim 1, wherein said particular information signals that the packet is of a particular type or packet format.

9. A method, comprising:
signaling, by a sending network node for interpretation by a receiving network node, particular information in a Time-to-Live (TTL) field of a packet sent to the receiving network node, with said particular information being other than a life span of the packet and other than distance information including distance information relative to the sending network node and distance information relative to the receiving network node.

10. The method of claim 9, wherein said particular information is said signaled by setting the TTL field to a particular value and sending the packet from the sending network node such that the value of the TTL field of the packet at the receiving network node will be interpreted as said particular information by the receiving network node after the packet has traversed one or more intermediate network nodes between the sending network node and the receiving network node including at least one of said one or more intermediate network nodes decreasing the value of the TTL field.

11. The method of claim 10, wherein said operation of interpreted as said particular information by the receiving node is based on the value of the TTL field being within a node-traversal-TTL-adjustment-accommodating range including at least two values.

12. The method of claim 11, wherein the node-traversal-TTL-adjustment-accommodating range includes at least sixteen different values.

13. The method of claim 10, wherein said particular information signals that the packet is not a normal data packet, that the packet is not a normal data packet, that the packet is an Operations, Administration or Maintenance (OAM) packet, that the packet is particularly marked, that the packet is particularly colored, that the packet is of a particular type, or that the packet is of a particular packet format.

14. The method of claim 10, wherein the particular value is at least thirty-two and less than 255.

15. The method of claim 10, wherein the packet is an IP packet.

16. The method of claim 10, wherein the packet is a Multiprotocol Label Switched (MPLS) MPLS packet.

17. The method of claim 10, wherein the packet is an Ethernet packet.

18. The method of claim 10, wherein said sending the packet from the sending network node includes sending, by the sending network node, the packet through a tunnel to and the receiving node, with the tunnel terminated on the receiving node.

19. A packet switching device, comprising:
one or more processing elements;
memory;
a plurality of interfaces configured for sending and receiving packets; and
one or more packet switching mechanisms configured to packet switch packets among said interfaces;
wherein said one or more processing elements are configured to perform operations, including interpreting a current value of a TTL field of a received packet to determine particular signaled information, with said particular signaled information being other than a life span of the packet and other than distance information.

20. The packet switching device of claim 19, wherein said interpreting the current value of the TTL field to determine particular signaled information includes determining that the current value of the TTL field is within a node-traversal-TTL-adjustment-accommodating range including at least two values.

21. The packet switching device of claim 19, wherein the current value of the TTL field is at least thirty-two and less than 252.

22. The packet switching device of claim 19, wherein said particular signaled information signals that the packet is not a normal data packet, that the packet is an Operations, Administration or Maintenance (OAM) packet, that the packet is particularly marked, that the packet is particularly colored, that the packet is of a particular type, or that the packet is of a particular packet format.
